(19) United States
(12) Patent Application Publication
(10) Pub. No.: US 2011/0171958 A1
(43) Pub. Date: Jul. 14, 2011

(54) MOBILE DEVICE USAGE MANAGEMENT VIA HOME SUBSCRIBER SERVER OPERATION AND PROFILE

(76) Inventors: Suzann Hua, Lisle, IL (US); Yigang Cai, Naperville, IL (US)

(21) Appl. No.: 12/685,226

(22) Filed: Jan. 11, 2010

(51) Int. Cl. H04W 60/00

(52) U.S. Cl. 455/435.2

(57) ABSTRACT

The present invention provides a method involving a mobile unit that is registered with a home subscription server. The method includes determining, at the home subscription server, a time interval during which the mobile unit is prohibited from registering for call sessions. The method also includes transmitting, from the home subscription server to a call session control function, a deregistration message instructing the call session control function to deregister the mobile unit during the time interval.

### BACKGROUND OF THE INVENTION

1. Field of the Invention

This invention relates generally to communication systems, and, more particularly, to wireless communication systems.

2. Description of the Related Art

Wireless communication systems use a network of access points such as base stations to provide wireless connectivity to user equipment within a geographic area served by the network. User equipment typically accesses the network at any desirable time to establish a call connection and/or a data connection. However, in some circumstances it may be desirable or necessary to limit access by particular user equipment during particular times of the day. For example, a parent may want to limit the use of a child's cell phone during school hours and/or at night. For another example, an employer may want to limit the use of an employer-provided smart phone during non-working hours. Service providers may therefore offer usage control applications that can be used to limit the use of user equipment.

Conventional usage control applications are implemented in a dedicated application server within the wireless communication system. The dedicated application server maintains records of the usage control restrictions that are applied to different user equipment. In operation, each time a user equipment attempts to initiate a call connection and/or a data connection, the wireless communication system accesses the dedicated application server and transmits an identifier of the user equipment along with a request to determine whether the requested connection is allowed. The dedicated application server uses the identifier to locate restrictions or rules that may be applied to the user equipment. If the requested connection does not violate any of the restrictions, then the application server transmits a signal back to the wireless communication system indicating that the connection is allowed. The wireless communication system may then continue with the connection process. However, if the requested connection violates one or more restrictions, then the application server transmits a signal back to the wireless communication system indicating that the connection should not be permitted. The wireless communication system may then interrupt the connection process and deny the requested connection.

Implementing usage control in a dedicated application server therefore requires that each switch or application associated with the requested connection must interface with the dedicated application server to determine whether the requested connection should be allowed or denied. Requiring this interface has a number of drawbacks. First, messages exchanged over the interface to determine whether to allow or deny the requested call increase overhead. For example, in addition to call registration/deregistration messages that are communicated between the switch or application and the home subscription server, usage control messages have to be exchanged between the switch or application and the application server. Second, interfacing with the application server can increase the delay between the time the connection is requested and the time that the decision to allow or deny the requested connection is made.

Device usage control could, in principle, be implemented in user equipment. However, UE-based usage control has not yet been implemented in any networks. Performing usage control at the user equipment would require extensive software enhancement to the user equipment. Consequently, it may not be practical to implement UE-based usage control in all legacy mobile devices and in cases where UE-based usage control can be implemented the usage control functionality may be limited by the legacy hardware, firmware, and/or software in the legacy user equipment.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided involving a mobile unit that is registered with a home subscription server. The method includes determining, at the home subscription server, a time interval during which the mobile unit is prohibited from registering for call sessions. The method also includes transmitting, from the home subscription server to a call session control function, a deregistration message instructing the call session control function to deregister the mobile unit during the time interval.

In another embodiment, a method is provided involving a mobile unit that is registered with a home subscription server. The method includes receiving, at a call session control function from the home subscription server, a deregistration message instructing the call session control function to deregister the mobile unit during a time interval during which the mobile unit is prohibited from registering for call sessions. The method also includes deregistering the mobile unit in response to receiving the deregistration message. Further, other embodiments of the method may include enhancing regular user equipment service profile with additional user equipment usage control profile that can be transmitted to the appropriate network elements such as PCRF in LTE network.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a wireless communication system;

FIG. 2 conceptually illustrates an exemplary embodiment of a method of providing usage control at a home subscriber server;

FIG. 3 conceptually illustrates another exemplary embodiment of a method of providing usage control at a home subscriber server; and

FIG. 4 conceptually illustrates a second exemplary embodiment of a wireless communication system.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally speaking, the present application describes a technique for utilizing a home subscription server (HSS) to provide usage control for mobile units and/or other user equipment based on the time-of-day (TOD). Exemplary embodiments of the techniques described herein can be used by parents to provide usage control to devices owned and/or operated by children, by employers to provide usage control to devices operated by employees, and the like. For example, parents can specify the TOD when the child device is not allowed to be used. The blocked TOD for the child device can be stored at the HSS. When the HSS determines that the blocked TOD has started, the HSS can send a deregistration message to a call control functions such as a serving Call Session Control Function (S-CSCF) implemented in the network. Once the child device has been deregistered by the coordinated operation of the HSS and the call control function, the child device cannot establish a voice or data connection with the network and therefore cannot be used for communication during the blocked TOD. The HSS also denies registration requests from child device during the blocked TOD. The child device can resume normal activities once the blocked TOD ends.

In some embodiments, the HSS may also establish and maintain a device usage control profile that can be created, configured, modified, and/or deleted by authorized parties, such as parents in the case of child device usage control and employer representatives in the case of the employee device usage control. The profile can contain white/black lists, priority lists, and group priority lists such as family plan priority lists. Every time the corresponding device registers to the network, the HSS can pass the usage control profile along with regular device profile to the appropriate call control entities in the network (such as the S-CSCF in an Internet Multimedia Subsystem (IMS) network or a policy control and rules function PCRF in a Long Term Evolution (LTE) network) via messaging such as the enhanced standard Diameter Cx protocol. The call control entity may then guide or execute usage control for the device.

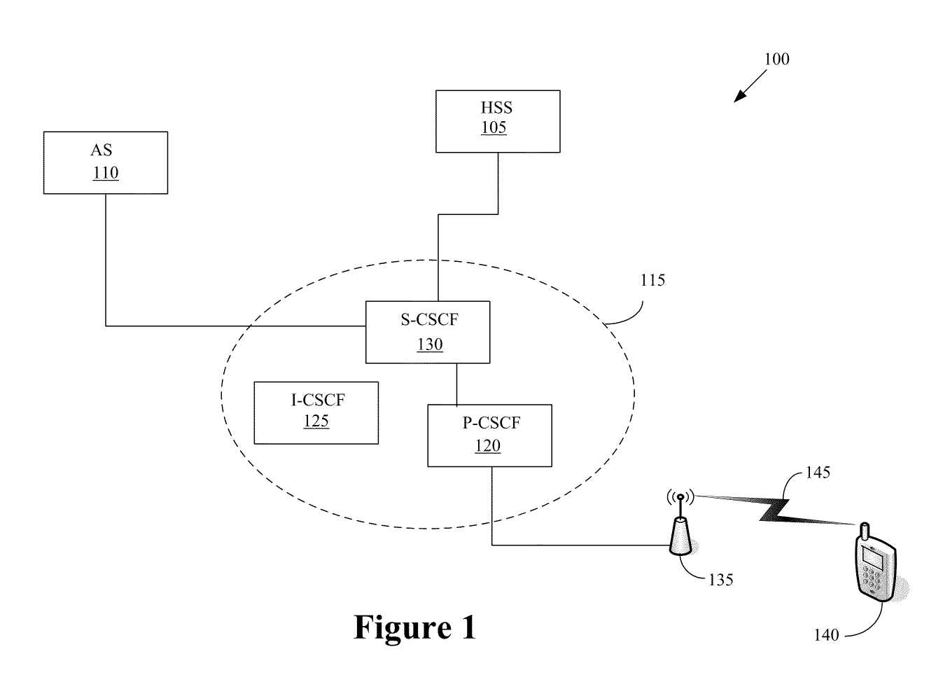

FIG. 1 conceptually illustrates a first exemplary embodiment of a wireless communication system 100. In the first exemplary embodiment, the wireless communication system 100 operates according to IMS protocols. However, persons of ordinary skill in the art having benefit of the present disclosure should appreciate that the wireless communication system 100 is not limited to the IMS protocols. In alternative embodiments, one of which is described herein, the wireless communication system 100 may operate according to other wired and/or wireless communication protocols. The wireless communication system 100 includes a home subscription server (HSS) 105, which may also be referred to as a User Profile Server Function (UPSF) in some embodiments. The HSS 105 includes a master user database that supports the IMS network entities that handle calls. The HSS 105 contains subscription-related information (e.g., subscriber profiles for registered user equipment), performs authentication and authorization of the users, and can provide information about the subscriber's location and IP information. The HSS 105 is also configured to perform device usage control based upon the time-of-day, as discussed herein.

The wireless communication system 100 also includes one or more application servers (AS) 110. Application servers host and execute services that are provided using applications supported by the application server 110. Depending on the service that is being provided, the application server 110 can operate in SIP proxy mode, SIP UA (user agent) mode or SIP B2BUA (back-to-back user agent) mode. In alternative embodiments, application servers 110 can be located in the home network and/or in an external third-party network. If located in the home network, application servers 110 can query the HSS 105 with the Diameter Sh interface (for a SIP-AS) or the Mobile Application Part (MAP) interface (for IM-SSF).

Although usage control can be implemented using the application server 110, the present application describes usage control that is implemented in the HSS 105. Consequently, the technique described herein does not require a dedicated network function or application server 110 to provide the usage control. Further, the technique described herein can be applied to any type of device (including personal computers, hand-held devices, etc) and doesn't require any hardware, firmware, and/or software enhancement at the device, as long as the device is subscribed to the HSS 105. In one embodiment, the techniques described herein can be based on the 3GPP standard interface/protocol and can be implemented in any service provider's IMS networks. Alternatively, e.g., with the new evolution of LTE/EPC, the HSS 105 can be configured to support multiple access technologies and different technology networks.

The HSS 105 and/or the application servers 110 can interface with a call control function 115. In the illustrated embodiment, the call control function 115 supports signaling and control within the IP Multimedia Subsystem (IMS) network. Subdivided into three separate parts, the CSCF 115 is responsible for signaling via Session Initiation Protocol (SIP) between the Transport Plane, the Control Plane, and the Application Plane. The CSCF 115 shown in the first exemplary embodiment depicted in FIG. 1 includes a Proxy CSCF (P-CSCF) 120, an Interrogating CSCF (I-CSCF) 125, and a Serving CSCF (S-CSCF) 130. The P-CSCF 120 is responsible for interfacing directly with the Transport Plane components and is the first point of signaling within IMS for any end-point. The P-CSCF 120 can be a proxy for SIP messages from end-points to the rest of the IMS network. The P-CSCF 120 is also responsible for policy decisions as it either has another IMS component called the Policy Decision Function (PDF) embedded (Release 5 of IMS), uses the COPS protocol to communicate with a standalone PDF (Release 6 of IMS), or interfaces via Diameter protocol to a Policy Charging, and Resource Function (PCRF) as an alternative stand-alone network element (Release 7 of IMS).

The I-CSCF 125 may be configured to act as a proxy between the P-CSCF 120 as entry point and S-CSCF 130 as a control point for applications found in the Application Plane, e.g., services implemented in the application server 110. For example, when the P-CSCF 120 receives a registration request SIP message, it will perform a DNS look-up to discover the appropriate I-CSCF 125 to route the message. Once the I-CSCF 125 receives the SIP message, it can perform an HSS look-up via Diameter to determine the S-CSCF 130 that is associated with the end-point terminal Once it receives this information, the I-CSCF 125 forwards the SIP message to the appropriate S-CSCF 130 for further treatment.

The S-CSCF 130 interfaces with the Application Servers 110 in the Application Plane and may also interface with the HSS 105. Upon receiving a registration request SIP message from an I-CSCF 125, the S-CSCF 130 queries the HSS 105 via Diameter protocol to register the terminal as being currently served by itself. The S-CSCF 130 may use credentials it obtains from the query to the HSS 105 to issue a SIP message “challenge” back to the initiating P-CSCF 120 to authenticate the terminal. In addition to acting as a registrar, the S-CSCF 130 may be responsible for routing SIP messages to the application servers 110 allowing for the Control Plane session control to interact with the Application Plane application logic

The call session control function 115 is communicatively coupled to an access network 135 for providing wireless connectivity. In various alternative embodiments, the access network 135 may include one or more devices such as a base station, a base station router, an access point that operates according to one of the IEEE standards and/or protocols, an access point that operates according to the Bluetooth standards and/or protocols, and the like. The access network 135 can communicate with one or more mobile units 140 over an air interface 145. For example, the mobile unit 140 can transmit a registration request message over the air interface 145 to the access network 135. The call session control function 115 may then query the HSS 105 to determine whether to accept or deny the requested call connection. As discussed herein, the HSS 105 may determine whether the mobile unit 140 is allowed to register for a call connection based upon the time-of-day (TOD).

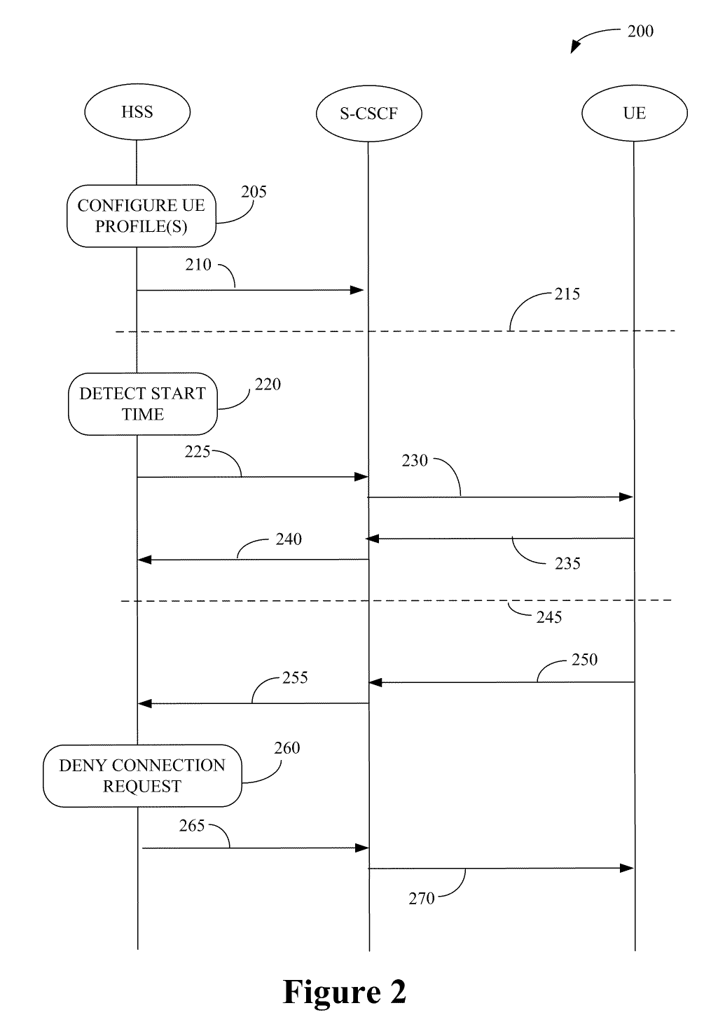

FIG. 2 conceptually illustrates one exemplary embodiment of a method 200 for determining whether to allow mobile units to establish a call connection based upon the time-of-day (TOD). In the exemplary embodiment, user profiles are established and configured (at 205) at the home subscriber server (HSS). The HSS can store (at 205) one or more time-of-day entries (TODs) for each user equipment (UE) that is subject to usage control by the HSS and subject to usage control for one or more prohibited time intervals. For example, authorized parties (such as parents and/or employers) may instruct the HSS to store one or more TODs that indicate time intervals for blocking or preventing call connections by the associated user equipment. In one embodiment, each TOD has a start time and an end time that can be indicated in the data stored on the HSS. The authorized party can configure the call usage control restrictions by calling the service provider to specify the blocked or prohibited TODs and/or verify authorization. Alternatively the authorized party can login to the service provider's web site to set up the blocked or prohibited TODs for the user equipment. The HSS can configure (at 205) a time based trigger function for each of the TODs and the associated user equipment, e.g., the HSS can be configured (at 205) to trigger a Cx Registration-Termination-Request (RTR) for the user equipment at each associated start time.

In one embodiment, configuring (at 205) the HSS may include establishing other user profile information and optionally delivering this information to a call control function or other network entity. For example, when the UE registers in an IMS network, the HSS may download (at 210) the usage control profile to the S-CSCF with ServiceInfo data as part of UE's service profile. The ServiceInfo data can contain a serviceIndication to indicate this data is a Usage Control Profile. The usage control profile stored at HSS should be accessible by authorized parties such as parents or service provider administrator for creation, viewing, and updating purpose. The profile may include but is not limited to a white list of operations that are always allowed, a black list of operations that are always prohibited, a conditional white list that indicates operations that are conditionally allowed (e.g., depending on time, location, call type, call direction, etc.), a conditional black list that indicates operations that are conditionally prohibited (e.g., depending on time, location, call type, call direction, etc.), an unconditional priority list, a conditional priority list, a group/family priority list, a calls/messages limitation per selected time period, and a call/messages type control list that indicates limitations for different types of calls or messages (e.g., Voice, SMS/MMS, IM, email, game, TV, etc).

The S-CSCF can fully or partially store the usage profile. In some embodiments, the S-CSCF may forward the full or partial profile to an Application Server (AS), e.g., via SIP 3rd party registration. The application server may then execute the usage control on the controlled device based on the downloaded portion of the usage profile. If an outgoing call or incoming call at the controlled user equipment is to be blocked by the application server based on the usage control profile, the application server may send a warning message to the controlled user equipment, as well as to the authorized party that configured the usage profile.

At this point, indicated by the dashed line 215, the home subscriber server and the call control function have been configured to support HSS-based call control using the TOD database. The HSS in this state monitors the time-of-day (e.g. using an internal clock or a timing signal provided by another entity) and checks to see whether the current time-of-day is substantially equal to the starting time for any prohibited time intervals for any of the user equipment that are registered with the HSS. Monitoring may be performed substantially continuously, at predetermined time intervals, or in response to any other trigger or request to compare the starting time for one or more user equipment to the current time-of-day.

The HSS detects (at 220) a start time associated with one or more of the user equipment registered with the HSS. Detecting (at 220) the start time means that the HSS has determined that the start time associated with the user equipment and the current time-of-day are the same within a selected tolerance. The start time and the current time-of-day are therefore the substantially the same. In one embodiment, the selected tolerance may be selected to be large enough to allow various other operations (such as creating and/or transmitting one or more messages) to be performed prior to the start time for the particular user equipment. The HSS sends (at 225) a deregistration message to the S-CSCF indicating that the user equipment associated with the start time is to be deregistered so that existing call connections to the user equipment are terminated and subsequent call connections are not allowed. For example, a trigger function can cause the HSS can send (at 225) a Cx Registration Termination Request (RTR) to the S-CSCF associated with the user equipment. The Cx RTR message can include a deregistration reason, such as PERMANENT TERMINATION or other terms that can be defined and provisioned to the appropriate network entities.

The S-CSCF can deregister the user equipment indicated in the message from the HSS and send (at 230) a message to the user equipment informing it that it has been deregistered. For example, in an IMS system, the S-CSCF can send (at 230) a SIP REGISTER with timer 0 via a P-CSCF to the user equipment to disable it. The user equipment may then respond (at 235) with a confirmation message, such as a 200 OK message. The S-CSCF may then respond to the HSS by sending (at 240) a confirmation message to the HSS indicating that the user equipment has been deregistered. At this point, indicated by the dashed line 245, the user equipment has been deregistered in response to the HSS detecting (at 220) a start time for a prohibited time interval associated with the user equipment.

Subsequent to deregistration of the user equipment at 245, the user equipment may attempt to access the system and establish a call connection. In the illustrated embodiment, the user equipment transmits (at 250) a request to establish a call connection to the network. The request is transmitted (at 250) to the S-CSCF, which then forwards (at 255) the request to the HSS to verify that the request to call connection should be allowed. In the illustrated embodiment, the HSS determines that the user equipment is in a prohibited time interval because the start time of the interval has been detected by the HSS. Consequently, the HSS denies (at 260) the requested call connection. A message is then transmitted (at 265) from the HSS to instruct the S-CSCF to deny the requested call connection. The S-CSCF therefore does not establish the requested call connection and transmits (at 270) a denial message to the user equipment. The HSS and the S-CSCF may continue to monitor, receive, and deny requests from user equipment throughout the duration of the prohibited time interval.

The HSS may also be used for usage control or roaming user equipment. In one embodiment, the HSS can deny calls if the HSS receives a connection request from roaming user equipment during a prohibited time interval. For example, if the HSS receives a Cx User-Authorization-Request (UAR) from a CSCF during a prohibited time interval, the HSS can return DIAMETER_ERROR_ROAMING_NOT_ALLOWED to the CSCF. Therefore the user equipment can be prohibited from registering. In one embodiment, the HSS may allow some call connection requests from the user equipment even though it is in a prohibited time interval. For example, the HSS may allow emergency calls from the user equipment or calls to particular numbers, such as numbers that have been specified in the usage profile by the authorized party.

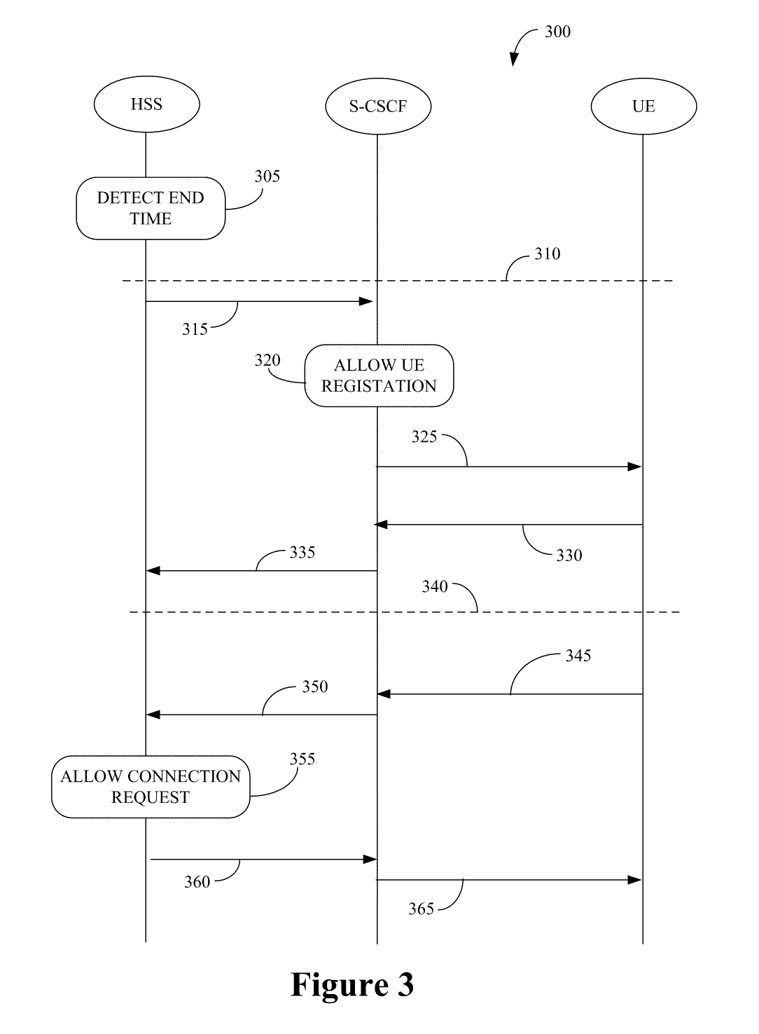

FIG. 3 conceptually illustrates another exemplary embodiment of a method 300 for determining whether to allow mobile units to establish a call connection based upon the time-of-day (TOD). In the illustrated embodiment, the HSS detects (at 305) an end time associated with one or more of the user equipment registered with the HSS. Detecting (at 305) the end time means that the HSS has determined that the end time associated with the user equipment and the current time-of-day are the same within a selected tolerance. The end time and the current time-of-day are therefore the substantially the same. In one embodiment, the selected tolerance may be selected to be large enough to allow various other operations (such as creating and/or transmitting one or more messages) to be performed prior to the end time for the particular user equipment. The HSS may then allow the user equipment to register and establish call connections using various alternative techniques.

In one alternative embodiment, which begins at the dashed line 310, the HSS sends (at 315) a registration message to the S-CSCF indicating that the user equipment associated with the end time is to be re-registered so that call connections to the user equipment are permitted. For example, a trigger function can cause the HSS can send (at 315) a Cx Registration Request to the S-CSCF associated with the user equipment. The Cx RTR message can include a registration reason (or other terms that can be defined and provisioned to the appropriate network entities) indicating that the user equipment is no longer in a prohibited time interval and may therefore establish call connections. The S-CSCF can register or re-register (at 320) the user equipment indicated in the message from the HSS and send (at 325) a message to the user equipment informing it that it has been registered or re-registered and can establish call connections with the network. The user equipment may respond (at 330) acknowledging the registration and the S-CSCF may also respond (at 335) to the HSS acknowledging the registration.

In another alternative embodiment, which begins at the dashed line 340 and which may be practiced separately from or in addition to other embodiments, the HSS may begin allowing connection requests following detection (at 305) of the end time of the prohibited time interval associated with user equipment. For example, user equipment may transmit (at 345) a request to establish a call connection to the network. The request is transmitted (at 345) to the S-CSCF, which then forwards (at 350) the request to the HSS to verify that the request to call connection should be allowed. In the illustrated embodiment, the HSS determines that the user equipment is not in a prohibited time interval because the end time of the interval has been detected (at 305) by the HSS. Consequently, the HSS allows (at 355) the requested call connection. A message is then transmitted (at 360) from the HSS to instruct the S-CSCF to allow the requested call connection. The S-CSCF may establish the requested call connection and transmit (at 365) a message to the user equipment indicating that the requested call connection may be established.

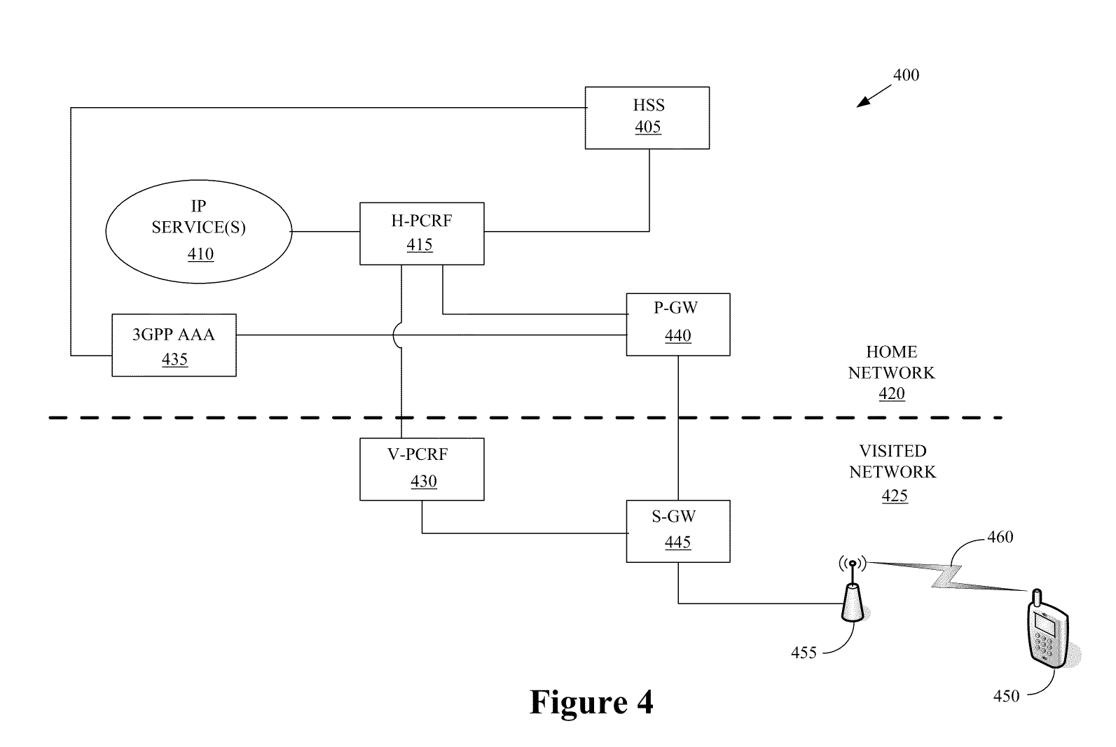

FIG. 4 conceptually illustrates a second exemplary embodiment of a wireless communication system 400. In the second exemplary embodiment, the wireless communication system 400 operates according to the Long Term Evolution (LTE) of the 3GPP/3GPP2 protocols. However, persons of ordinary skill in the art having benefits of the present disclosure should appreciate that the wireless communication system 400 is not limited to the LTE protocols. In alternative embodiments, the wireless communication system 400 may operate according to other wired and/or wireless communication protocols. The wireless communication system 400 includes a home subscription server (HSS) 405 that includes a master user database that supports the LTE network entities that handle calls. The HSS 405 contains the subscription-related information (e.g., subscriber profiles for registered user equipment), performs authentication and authorization of the users, and can provide information about the subscriber's location and IP information. The HSS 405 is also configured to perform device usage control based upon the time-of-day, as discussed herein.

The wireless communication system 400 also includes one or more service entities 410 that service providers and/or operators can use to provide application services or IP services (e.g., according to IMS or PSS protocols). The service entities 410 may include one or more application servers (not shown in FIG. 4). As discussed herein, the present application describes usage control that is implemented in the HSS 405 and therefore the techniques described herein do not require a dedicated network function or application server (such as can be implemented in the service entities 410) to provide the usage control. Further, the technique described herein can be applied to any type of device (including personal computers, hand-held devices, etc) and doesn't require any software enhancement at the device, as long as the device is subscribed to the HSS 405. In one embodiment, the techniques described herein can be based on the 3GPP standard interface/protocol and can be implemented in networks that support the new evolution of LTE/EPC. The HSS 405 can be configured to support multiple access technologies and different technology networks.

The HSS 405 can communicate with a policy control and charging rules function (PCRF) 415, e.g., over an Sp(Sh) interface. The PCRF 415 provides network control rules regarding the service data flow detection, gating, and quality of service and/or flow-based charging. For example, the PCRF 415 can determine various policy and charging control (PCC) rules and transmit these rules to other functional entities in the network. In some cases, the PCRF 415 determines the PCC rules based upon subscription information associated with a subscriber and stored in a subscription profile repository (SPR). In the illustrated embodiment, the wireless communication system 400 includes a home network 420 and one or more visited networks 425 for user equipment. Each network includes a separate PCRF so that the home network 420 includes a home PCRF 415 and the visited network 425 includes a visited PCRF 430. The two PCRF entities 415, 430 can communicate (e.g., over an S9 interface) to handle roaming user equipment.

An authorization, authentication, and accounting server (AAA) 435 is used to authorize access to the network, authenticate user equipment, and handle accounting for the services and/or resources provided to user equipment. Techniques for configuring, implementing, maintaining, and/or operating the AAA server 435 are known in the art and in the interest of clarity only those aspects of configuring, implementing, maintaining, and/or operating the AAA server 435 that are relevant to the claimed subject matter will be discussed herein. The AAA server 435 can communicate with the HSS 405, e.g., over a Wx interface, so that the AAA server 435 can access information associated with the user equipment and stored on the HSS 405.

The wireless communication system 400 also includes a packet data node (PDN) Gateway (P-GW) 440. The PDN Gateway 440 provides connectivity from user equipment to external packet data networks by being the point of exit and entry of traffic for user equipment, which may have simultaneous connectivity with more than one PGW for accessing multiple PDNs. The P-GW 440 performs policy enforcement, packet filtering for each user, charging support, lawful interception and packet screening. Another role of the P-GW 440 is to act as anchor for mobility between 3GPP and non-3GPP technologies such as WiMAX and 3GPP2 (CDMA 1X and EvDO).

The P-GW 440 communicates with one or more serving gateways (S-GWs) 445 in the visited networks 425. Each S-GW 445 routes and forwards user data packets, while also acting as mobility anchor for the user plane during inter-eNodeB handovers and as anchor for mobility between LTE and other 3GPP technologies (e.g., by terminating S4 interface and relaying the traffic between 2G/3G systems and PGW). For user equipment that are in the idle state, the S-GW 445 can terminate the downlink data path and trigger paging when downlink data arrives for the user equipment. The S-GW 445 may also manage and store user equipment contexts such as parameters of the IP bearer service, network internal routing information. The S-GW 445 may also perform replication of the user traffic in case of lawful interception.

In the illustrated embodiment, user equipment includes a mobile unit 450 that is registered with the HSS 405 is roaming in the visited network 425. The S-GW 445 therefore provides a network entry point and supports communication with one or more base stations 455 that provide wireless connectivity to the mobile unit 450 over an air interface 460. However, persons of ordinary skill in the art having benefit of the present disclosure should appreciate that the mobile unit 450 may not always be roaming to the visited network 425 and the techniques described herein apply equally when the mobile unit 450 is in its home network 420. In that case, the P-GW 440 (or other gateway within the home network 420) provides the network entry point for the mobile unit 450.

In one embodiment, usage control profiles may be downloaded to PCRF 415, 430 in the LTE network 400. For example, whenever the PCRF 415, 430 retrieves user equipment policy and charging data, the predefined usage control profiles (e.g., the usage control profiles defined by authorized parties such as parents or employers) for the user equipment can be downloaded as part of policy and charging data. The PRCF 415, 430 can retrieve user equipment policy/changing data along with the corresponding usage control profile data via enhanced standard Sh protocol. The PCRF 415, 430 may then instruct S-GW 440 or P-GW 445 when executing usage control.

In operation, the HSS 405 works in coordination with the PCRF 415, 430 to enforce usage control for user equipment (such as the mobile unit 450) based on the time-of-day. For example, user profiles may be established and configured at the HSS 405. The user profiles include one or more time-of-day entries (TODs) for user equipment (UE) subject to usage control by the HSS 405 for one or more prohibited time intervals. For example, authorized parties (such as parents and/or employers) may instruct the HSS 405 to store one or more TODs that indicate time intervals for blocking or preventing call connections by the associated user equipment. In one embodiment, each TOD has a start time and an end time that can be indicated in the data stored on the HSS.

The HSS 405 transmits a deregistration message to the PCRF 415, 430 when it detects the start time of the prohibited interval of the mobile unit 450. The information in this message is used by the PCRF 415, 430 to deregister the mobile unit 450 substantially at the starting time of the prohibited interval. For example, the PCRF 415, 430 may create or modify one or more rules or policies that indicate that the mobile unit 450 is to be deregistered substantially at the starting time and may then communicate these rules or policies to appropriate entities in the wireless communication system 400, such as the base station 455. Techniques for establishing the rules and/or policies and the messages/signaling used to convey these rules and/or policies to entities within the wireless communication system are known in the art and in the interest of clarity will not be discussed further herein. The HSS 405 and/or the PCRF 415, 430 may also deny any subsequent communication requests from the mobile unit 450 during the prohibited time interval, as discussed herein.

Once the HSS 405 detects the end time of the prohibited interval, call connection requests from the mobile unit 450 may be allowed. In one embodiment, the HSS 405 transmits a message to the PCRF 415, 430 indicating that the prohibited time interval has expired and the mobile unit 450 is again permitted access to the wireless communication system 400. The PCRF 415, 430 may create or modify one or more rules or policies that indicate that the mobile unit 450 is permitted access to the wireless communication system 400 and may then communicate these rules or policies to appropriate entities in the wireless communication system 400, such as the base station 455. In one alternative embodiment, which may be practiced instead of or in addition to other embodiments, the HSS 405 may begin allowing requests for call connections that are received from the mobile unit 450 substantially at or after the ending time of the prohibited time interval.

Implementing usage controls at the home subscriber server has a number of advantages over conventional practice. For example, the techniques described herein do not require dedicated network functions (such as services implemented in a separate application server) or modifications of the hardware, firmware, and/or software of user equipment. The HSS-based usage controls can be implemented using 3GPP standard interfaces and/or protocols and can be implemented in any service provider IMS network. Furthermore, the functionality used to implement HSS-based usage controls are straightforward to provision to the HSS, utilize simple functions to achieve TOD control, and may be extended for multiple purposes

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method involving a mobile unit that is registered with a home subscription server, comprising:
determining, at the home subscription server, a time interval during which the mobile unit is prohibited from registering for call sessions; and
transmitting, from the home subscription server to a call session control function, a deregistration message instructing the call session control function to deregister the mobile unit during the time interval.

2. The method of claim 1, wherein determining the time interval comprises accessing information indicating a starting time and an ending time for the time interval from a database stored by the home subscription server.

3. The method of claim 2, comprising:
receiving, from an authorized party, information indicating the starting time and the ending time of the time interval during which the mobile unit is not allowed to register for call sessions; and
storing, in the database at the home subscription server, information indicating the starting time and the ending time of the time interval associated with the mobile unit.

4. The method of claim 3, comprising authorizing, at the home subscription server, the authorized party to create, modify, or delete information in the database indicating the starting time or the ending time of the time interval during which the mobile unit is not allowed to register for call sessions.

5. The method of claim 1, wherein transmitting the deregistration message comprises transmitting a registration termination request from the home subscription server to the call session control function and comprising receiving, at the home subscription server from the call session control function, a registration termination answer in response to the registration termination request.

6. The method of claim 1, comprising determining that the mobile unit is roaming and wherein transmitting the deregistration message comprises transmitting the deregistration message when the mobile unit is roaming.

7. The method of claim 1, comprising registering the mobile unit with the home subscription server and establishing, in the home subscription server, a usage control profile for the mobile unit.

8. The method of claim 7, comprising downloading, from the home subscription server to an application server, the usage control profile for the mobile unit.

9. The method of claim 8, wherein establishing the usage control profile comprises establishing a usage control profile comprising at least one of a white list, a black list, a conditional white list, a conditional black list, an unconditional priority list, a conditional priority list, a group/family priority list, a call/message limitation per period, or a call/message type control list

10. The method of claim 1, comprising allowing the mobile unit to register for call sessions after the time interval.

11. The method of claim 10, wherein allowing the mobile unit to register for call sessions comprises transmitting a message from the home subscription server instructing the call session control function to allow the mobile units to register for call sessions.

12. The method of claim 10, wherein allowing the mobile unit to register for call sessions comprises allowing a request for a call session received from the mobile unit.

13. A method involving a mobile unit that is registered with a home subscription server, comprising:
receiving, at a call session control function from the home subscription server, a deregistration message instructing the call session control function to deregister the mobile unit during a time interval during which the mobile unit is prohibited from registering for call sessions; and
deregistering the mobile unit in response to receiving the deregistration message.

14. The method of claim 13, wherein receiving the deregistration message comprises receiving the deregistration message in response to the home subscription server determining a starting time for the time interval by accessing information indicating the starting time from a database stored by the home subscription server.

15. The method of claim 13, wherein receiving the deregistration message comprises receiving a registration termination request at the call session control function from the home subscription server and comprising transmitting, from the call session control function to the home subscription server, a registration termination answer in response to the registration termination request.

16. The method of claim 13, wherein deregistering the mobile unit comprises sending a message to the mobile unit that disables the mobile unit.

17. The method of claim 13, comprising downloading, from the home subscription server, the usage control profile for the mobile unit.

18. The method of claim 17, wherein downloading the usage control profile comprises downloading a usage control profile comprising at least one of a white list, a black list, a conditional white list, a conditional black list, an unconditional priority list, a conditional priority list, a group/family priority list, a call/message limitation per period, or a call/message type control list.

19. The method of claim 13, comprising allowing the mobile unit to register for call sessions after an ending time for the time interval determined by the home subscription server using information stored in the database.

20. The method of claim 19, wherein allowing the mobile unit to register for call sessions comprises receiving a message from the home subscription server instructing the call session control function to allow the mobile units to register for call sessions.

21. The method of claim 20, wherein allowing the mobile unit to register for call sessions comprises transmitting, from the call session control function to the home subscription server, a request for a call session received from the mobile unit and receiving, at the call session control function from the home subscription server, a message allowing the requested call session.
